(19) United States
(12) Patent Application Publication
(10) Pub. No.: US 2010/0318272 A1
(43) Pub. Date: Dec. 16, 2010

(54) METHOD OF CONTROLLING A BRAKING SYSTEM

(75) Inventors: Christophe Bouchard, Argenteuil (FR); Eric Bisserier, Obersulm (DE); Laurent Wagon, Reims (FR); Laurent Clercin, Athies sous Laon (FR); Pascal Trefert, Berry-au-Bac (FR)

Correspondence Address: MICHAEL BEST & FRIEDRICH LLP, 100 EAST WISCONSIN AVENUE, MILWAUKEE, WI, 53202, US

(73) Assignee: ROBERT BOSCH GMBH, Stuttgart (DE)

(21) Appl. No.: 12/815,667

(22) Filed: Jun. 15, 2010

(30) Foreign Application Priority Data
Jun. 15, 2009 (FR) 0902907

(51) Int. Cl. B60T 8/26; G06F 19/00; B60T 8/00

(52) U.S. Cl. 701/70

(57) ABSTRACT

A method of controlling a braking system of a vehicle, aimed at preventing the rear axle of the vehicle from lifting under braking. More particularly, a method for controlling a braking system (19) in a vehicle (1), the vehicle comprising at least one front wheel (5) and at least one rear wheel (3), characterized in that it comprises the following steps: determining whether there exists at least one condition under which the rear wheel (3) will lift, and if it does exist, limiting and/or reducing the braking effort applied to the front wheel (5) by the vehicle braking system.

### BACKGROUND OF THE INVENTION

The present invention relates to a method of controlling a braking system. More specifically, the invention relates to a method of controlling a braking system of a vehicle, aimed at preventing the rear axle of the vehicle from lifting under braking. The invention is described in the case of automotive vehicles but may be applied to other fields. The method according to the present invention works particularly well for vehicles having at least three wheels and preferably 4 or more wheels. This is because 2-wheeled motor vehicles, chiefly motorcycles, behave in a completely different way from a motor car inasmuch as the position (weight distribution) and rigidity (applied forces) of the driver have an influence on any lifting of the front wheel or of the rear wheel of the motorbike. Furthermore, liftings of the front or rear wheel may be considered by the rider to contribute to the enjoyment of the sporty riding of their motorbike.

Methods of controlling a braking system are described notably in U.S. Pat. No. 5,386,366, EP 0 537 724, DE 10 2005 054557, EP 1 839 978 and EP 1 386 804.

Some vehicles, for example of the utility vehicle type, are designed to carry relatively heavy loads. Typically, a space intended to carry said load is situated at the rear of the vehicle. Said vehicle is therefore balanced to account for a significant additional weight situated at its rear.

Now, this type of vehicle is sometimes used unladen. When this happens, the center of gravity of the vehicle is shifted forward in relation to a vehicle that is laden. If a utility vehicle that is driving around unladen experiences sudden sharp braking, the rear part of said vehicle sometimes does not have enough inertia in relation to the front part. This then causes the rear axle of the vehicle to lift. Such lifting is uncomfortable and dangerous to users of the vehicle. What is more, if excessive, it may cause the vehicle to topple.

At the present time, the prior art has no solution for combating this phenomenon of vehicle rear axle lift.

Furthermore, a great many present-day vehicles are equipped with brake assist systems such as systems of the ABS (Antilock Braking System) type. Electronic stability programs (ESP) which correct the trajectory of the vehicle, are also known.

An ABS system regulates the braking power of each wheel, to prevent the wheels from locking up and skidding under braking. An ESP system avoids and/or corrects instabilities in the course followed by the vehicle, by applying selective braking to one or more wheels.

In order to be able to influence the way in which the vehicle behaves in terms of braking and course, the ABS and the ESP system need to use a large amount of information. This information relates both to the characteristics and to the behavior of the vehicle.

In order to obtain this information, a vehicle is fitted with various sensors, notably speed sensors, distributed at the wheel sets and in the steering. On the basis of the information transmitted by these sensors, the ESP system and the ABS perform calculations to determine whether there is a discrepancy between desired values (for example of speed or deceleration) and the measured actual values. Following these calculations, the ESP system and the ABS define commands to be applied by the braking systems.

For example, if one wheel is slowing abnormally under braking (that is to say is locking up), the ABS releases the pressure in the braking circuit at this wheel, until this wheel has reaccelerated sufficiently. The system operates in successive pulses.

The ESP system may itself initiate selective braking on one or more of the outside wheels of a vehicle when it detects that this vehicle is experiencing oversteer. It may initiate selective braking on one or more of the inside wheels of a vehicle when it detects that this vehicle is experiencing understeer.

These devices are commonly used in the design of present-day vehicles. It would therefore be advantageous to propose a method for controlling a braking system in a vehicle that aims to avoid rear axle lift under braking and that is able to involve some elements of the ABS and/or ESP system.

### SUMMARY OF THE INVENTION

One subject of the present invention is therefore a method for controlling a braking system in a vehicle, the vehicle comprising at least one front wheel and at least one rear wheel, characterized in that it comprises the following steps: determining whether there exists at least one condition under which the rear wheel will lift, and if at least one such condition is determined as existing, limiting and/or reducing the braking effort applied to the front wheel by the vehicle braking system.

According to a preferred embodiment of the invention, a condition of lifting of the rear wheel is determined as existing when a deceleration of the vehicle exceeds a predetermined value.

According to a preferred embodiment of the invention, a condition of lifting of the rear wheel is determined as existing when a deceleration of the rear wheels exceeds a predetermined value.

According to a preferred embodiment of the invention, a condition of lifting of the rear wheel is determined as existing when a ratio of speeds of the front wheel and of the rear wheel exceeds a predetermined value.

According to a preferred embodiment of the invention, a condition of lifting of the rear wheel is determined as existing when a ratio of decelerations of the rear wheel and of the front wheel exceeds a predetermined value.

According to a preferred embodiment of the invention, a condition of lifting of the rear wheel is determined as existing when a speed of slipping of at least one of the wheels exceeds a predetermined value.

Another subject of the present invention is a device for controlling a braking system in a vehicle, the vehicle comprising at least one front wheel and at least one rear wheel, characterized in that it comprises means for implementing a method as described hereinabove.

Another subject of the present invention is a method, a device and a vehicle all as claimed in the claims.

Another subject of the present invention is a vehicle fitted with such a device.

### BRIEF DESCRIPTION OF THE DRAWINGS

The invention will be better understood from reading the description which follows and from studying the accompanying figures. These figures are given solely by way of nonlimiting indication of the invention. The figures show:

FIG. 1: a vehicle that can be fitted with means for implementing a method according to the invention,

FIG. 2: a schematic depiction of a device comprising means for implementing a method according to the invention.

### DETAILED DESCRIPTION

The references listed hereinbelow correspond to the various elements of the method according to the invention and of the devices that implement this method:
1—vehicle
2—rear axle
3—rear wheel
4—front axle
5—front wheel
6—cabin
7—front part of the vehicle 1
8—rear part of the vehicle 1
9—sensor
10—device implementing the method according to the invention
11—device for controlling a braking system
12—bus
13—microprocessor
14—bus
15—program memory
16—data memory
17—interface for communicating with the sensors 9
18—interface for communicating with the system 19
19—braking system of the vehicle 1
20—software

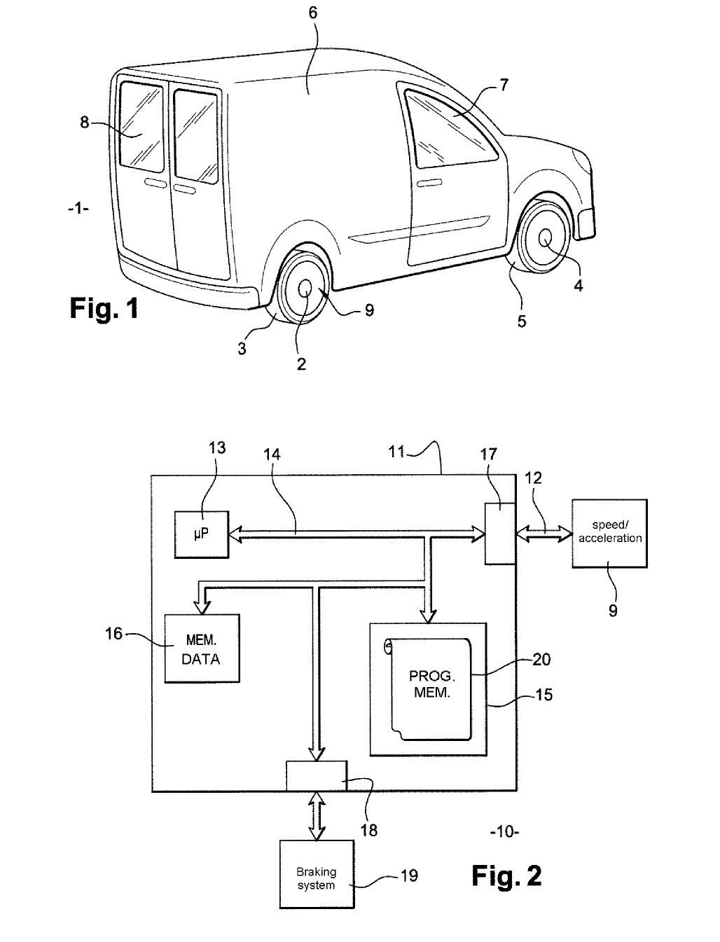

FIG. 1 depicts a perspective view of a vehicle that can be fitted with means for implementing a method according to the invention. This is a vehicle 1 of utility vehicle type. It notably comprises a rear axle 2, fitted with two rear wheels 3. The vehicle 1 also has a front axle 4 fitted with two front wheels 5. In the conventional way, the front 5 and rear 3 wheels are equipped with brakes, which are controlled by a braking system.

The vehicle 1 also comprises a cabin 6, which is split into two parts. A front part 7 is intended to accommodate a driver of the vehicle 1. A rear part 8 is intended to accommodate the objects that are to be transported. Typically, the part 8 is able to accommodate a significant volume of objects. For example, its capacity is vastly superior to that of the luggage compartment of a family car.

It is commonplace for the vehicle 1 to be driven around with a substantial load in its rear part 8. From its design, the vehicle 1 is therefore balanced to account for a significant additional weight situated in its rear part 8.

However, the vehicle 1 is sometimes driven without a load in its rear part 8. When this happens, a center of gravity of the vehicle 1 is closer to the front part 7 than it is when the vehicle 1 is laden.

If the vehicle 1 driving around without a load in its rear part 8 experiences sudden heavy braking, said part 8 sometimes does not have enough inertia with respect to the front part 7. The rear axle 2 of the vehicle then lifts in relation to the front axle 4. This lift may go so far as to cause the rear wheels 3 to lose contact with the ground. Such lift is uncomfortable and dangerous to users of the vehicle 1. In addition, if excessive, it may cause the vehicle 1 to topple.

It is therefore advantageous for the vehicle 1 to be equipped with means of implementing a method for controlling the braking system, this method being aimed at preventing the rear wheels 3 from leaving the ground under sudden sharp braking. The theory behind such a method is similar to the theory that governs an ABS. It involves helping the driver to keep control over his vehicle in an emergency braking situation.

A method according to the invention notably comprises the following steps: Measuring speeds and/or accelerations/decelerations of elements of the vehicle 1. This may be the speed of travel of the vehicle 1, the rotational speed of the front 5 and/or rear 3 wheels, a ratio between the speeds of the front 5 and rear 3 wheels or alternatively a speed at which the front and/or rear wheels slip along the ground. Comparing one or more of these measurements against one or more predetermined value(s). For example, a condition under which the rear wheel might lift is considered to have been reached if at least one of the measured values exceeds a predetermined value. If a condition under which the rear wheel might lift is reached, limiting and/or reducing the braking effort applied to the front wheel by the vehicle braking system.

Thus, when the rear axle of the vehicle lifts, a method according to the invention commands a reduction in the braking effort to the front axle 4. The deceleration of the front part 7 of the vehicle 1 is thereby decreased. This reestablishes equilibrium between the speeds of the front part 7 and of the rear part 8, the previous imbalance being due to the difference in inertia of said parts 7 and 8. Thus, the rear axle 2 stops lifting and the rear wheels 3 come back into contact with the ground.

Measuring the speeds and/or accelerations/decelerations of elements of the vehicle 1 entails fitting the vehicle 1 with various sensors 9. These sensors are notably situated on the front axle 4 and on the rear axle 2. It is possible to use sensors that form part of an ABS and/or of an ESP system with which the vehicle 1 might also be equipped.

FIG. 2 shows a device comprising means for implementing the method according to the invention. This device is intended to be fitted to a vehicle, such as the vehicle 1 for example. This device 10 comprises one or more sensors 9. These sensors are located at various points in the vehicle 1, notably on the front axle 4 and/or the rear axle 2. These sensors 9 are able to take measurements of speed and/or acceleration/deceleration. These sensors 9 may also form part of an ABS and/or of an ESP system with which the vehicle 1 is equipped.

The sensor or sensors 9 are linked to a device 11 for controlling a braking system of the vehicle 1. One sensor 9 is, for example, connected to the device 11 via a bus 12. The device 11 may comprise a microprocessor 13, connected by a bus 14 to a program memory 15, a data memory 16, an interface 17 for communicating with the sensor or sensors 9 and an interface 18 for communicating with a braking system 19 of the vehicle 1.

For this, the memory 15 stores software 20. This software 20 is able to process the data transmitted by the sensors 9, to compare them against values stored in the data memory 16 and to forward an appropriate response to the braking system 19, via the interface 18.

According to one embodiment of the invention, the software 20 considers a deceleration in the travel of the vehicle 1 and compares it against a predetermined value, stored in the memory 16. Too sudden a deceleration of the vehicle 1 can, in this case, be considered to be a condition under which the rear wheels 3 will lift.

According to another embodiment of the invention, the software 20 considers a deceleration in the rotational speed of a rear wheel 3 and compares it against a predetermined value stored in the memory 16. Too sharp a deceleration in the rotational speed of a front wheel 5 can, in this case, be considered to be a condition under which the rear wheels 3 will lift.

According to another embodiment of the invention, the software 20 considers both a rotational speed of a front wheel 5 and a rotational speed of a rear wheel 3. When the vehicle 1 is under braking, the braking system typically acts on the front wheels 5 and the rear wheels 3. However, the front wheels 5 are in contact with the ground. They therefore experience drive and their rotational speed does not immediately drop to zero. If it did, the vehicle would skid. The purpose of an ABS is, in particular, to prevent the wheels from locking so as to prevent the vehicle from skidding.

If the rear axle 2 lifts and the rear wheels 3 lose contact with the ground, they do not experience the same drive as the front wheels 5. Because of the action of the braking system, their rotational speed drops rapidly. Too great a ratio between a rotational speed of a front wheel 5 and a rotational speed of a rear wheel 3 can therefore be considered to be a condition in which the rear wheels 3 will lift. It is also possible to consider too great a difference between said speeds, that is to say the result of subtracting one of the speeds from the other, rather than dividing one by the other.

It is also possible to compare the decelerations of the wheels rather than their speeds. In this case, too great a ratio between a deceleration of a rear wheel 3 and a deceleration of a front wheel 5 can be considered to be a condition in which the rear wheels 3 will lift.

According to another embodiment of the invention, the software 20 considers a speed of slipping of the front 5 and/or rear 3 wheels along the ground. This speed of slipping may, for example, be obtained by comparing a rotational speed of the wheel 3 or 5 and a speed of travel of the vehicle 1.

When the rear wheels 3 have lifted off the ground, there will be no effective slipping of said wheels 3. However, a value may be obtained by comparing the speeds above.

According to this embodiment of the invention, a slipping of the wheels above a certain threshold can be considered to correspond to sudden sharp braking, it being possible for this braking to be a condition in which the rear wheels 3 will lift.

According to the present invention, the threshold at which the system according to the present invention is initiated can be adjusted in order either to reduce the likelihood of the system not being initiated at all or being initiated with a delay in the event of the rear wheels lifting (the false-negative rate) or, on the other hand, in order to increase the rate of initiation up to almost 100%, at the expense of a lengthening of stopping distances and/or of the time taken to slow the vehicle down. However, the fineness and relevance of the choice of the criterion or criteria that determine the initiation of the system and, advantageously, a reduction in the intensity of the intervention in cases where the probability of entering a wheel-lift situation is low, mean that improved outcomes can be had on at least one, and preferably both, aspects (false-negative rate/stopping distance). These criteria are advantageously chosen as a function, on the one hand, of the mechanical behavior of the vehicle ground-contact system and, on the other hand, as a function of the type of presumed usage by its driver. For example, for a sporty vehicle and for the purposes of sporty driving, a reduction in stopping distances will take preference. By contrast, on a family vehicle and, even more so on a utility vehicle, it may prove advantageous to reduce the risk of non-initiation of the system or of a delay in its initiation. A vehicle will be considered to have a good ground-contact system if the ratio between the height of its center of gravity and the distance between the front axle and the transverse plane that passes through its center of gravity is small. Advantageously, the system according to the invention is set up for vehicles in which the ratio is greater than 1.2 so as to avoid non-initiation or delay in initiation in the event of wheel lift (negligible false-negative rate). It has been found that the initiation criterion corresponding to a vehicle deceleration of less than 7 m/s² has a detrimental overall influence on the dynamic behavior of the vehicle, that is to say that the stopping distances are lengthened without any significant improvement in terms of the detection rate which is, in any case, around 100%. Advantageously, the criterion for initiation of intervention of the system according to the invention is greater than or equal to 7 m/s², which corresponds to a good balance between stopping distances and false-negative rates for a vehicle that has a ratio between the height of its center of gravity and the distance between the front axle and the transverse plane passing through its center of gravity that is high (minivan, light duty vehicle, SUV). Advantageously, the initiation criterion corresponds to a deceleration of the vehicle greater than or equal to 9 m/s² for the majority of vehicles driven by their usual driver. For vehicles with a sporty behavior having more than 2 driven wheels, typically for vehicles known as 4×4s, and/or for vehicles intended for drivers who have a sporty driving style and are capable of controlling a vehicle should the rear wheels lift under exceptional circumstances (false-negative rate very low but not completely negligible), use will be made of an initiation criterion that corresponds to a deceleration of the vehicle of between 9.2 m/s² and 10.3 m/s², preferably between 9.3 m/s² and 10 m/s², for example equal to 9.5 m/s² or 9.7 m/s².

Furthermore, it is possible, in particularly advantageous embodiments of the present invention, to improve on the outcome still further in relation to one or other (or both) of the criteria (stopping distance/false-negative rate) by combining them with a second criterion using an “AND” logic function. In a first advantageous variant of the invention, the second criterion corresponds, for vehicle rear wheels that are subject to an ABS action, to the slipping of the rear wheels. For preference, the slipping, with the ABS switched on, is greater than 1%, preferably lying between 1.9% and 5%, for example equal to 1.9%, 2%, 2.2% or 3%. Advantageously, more severe initiation criteria are used (accepting a higher false-negative rate) for sports vehicles and/or for vehicles having more than 2 driven wheels (4×4s, etc.).

In another variant of the invention, the first criterion (vehicle deceleration) is combined with a third criterion regarding the (positive) tangential acceleration of the wheels (under braking) using the “AND” logic function. For preference, the positive tangential acceleration of the wheels of the third criterion lies between 2.5 m/s² and 7 m/s², preferably between 3 m/s² and 6 m/s², more preferably still between 3.5 m/s² and 5.5 m/s², for example equal to 3.5 m/s², 4 m/s² or 5 m/s². Advantageously, more severe initiation criteria are used (accepting a higher false-negative rate) for sporty vehicles and/or vehicles that have more than 2 driven wheels (4×4s, etc.).

In the preferred embodiment, “AND” functions are used to combine the first, second and third criteria. In other words, the braking reduction system is initiated or the intensity thereof is increased when the deceleration of the vehicle is above a threshold, for example equal to 8 m/s² and (at the same time) the slipping of the rear wheels is above a threshold for example equal to 2% and (at the same time) the tangential positive acceleration of the rear wheels is above a threshold for example equal to 5 m/s².

Combining the two and, better still, the three initiation criteria makes it possible either: to reduce the residual rate of lift of the rear wheels; to increase the individual threshold value of the first, second or third initiation criteria or the combination thereof suited to the vehicle to be equipped, thus reducing stopping distances or the time taken to slow the vehicle down under emergency braking conditions.

It is also possible, depending on the vehicle manufacturer's specification, to effect a trade off in order to obtain a combination of the aforementioned features a) and/or b).

When a condition in which the rear wheels 3 will lift is considered to exist, the software 20 sends a command to the braking system 19 via the interface 18. The purpose of this command is to reduce or limit the braking of the front wheels 5. For example, the braking power may be reduced by a certain percentage, said percentage being related to a discrepancy between a value measured by a sensor 9 and a value stored in the memory 16. A look-up table linking said discrepancies and said percentages may be stored in the memory 16. Advantageously, the table is set for a given vehicle. However, a table that can be varied through learning and/or by storing a plurality of tables (for example a table suited to a calm driving style, a table suited to a normal driving style, and a table suited to a sporty driving style) would not constitute a departure from the scope of the present invention. The vehicle computers identify the type of driving style employed by the driver and choose the table best suited to the style identified.

It is also possible to impose a maximum threshold on braking power, this threshold being connected to a discrepancy between a value measured by a sensor 9 and a value stored in the memory 16. A look-up table relating said discrepancies and said thresholds may be stored in the memory 16.

Following a command transmitted by the software 20, the braking system 19 of the vehicle 1 reduces or limits the braking of the front wheels 5. In the case of a hydraulic braking system, the pressure of the hydraulic braking unit decreases at the front wheels 5. The decrease in the deceleration of the front wheels 5 allows the rear wheels 3 to regain contact with the ground.

According to a preferred embodiment of the invention, a device like the one depicted in FIG. 2 is incorporated into an ABS device or into an ESP device with which the vehicle 1 may moreover already be equipped.

1. Method for controlling a braking system (19) in a vehicle (1), the vehicle comprising at least one front wheel (5) and at least one rear wheel (3), the method comprising: determining whether there exists at least one condition under which the rear wheel (3) will lift, and if at least one such condition is determined as existing, limiting and/or reducing the braking effort applied to the front wheel (5) by the vehicle braking system (19).

2. Method according to claim 1, characterized in that a condition of lifting of the rear wheel is determined as existing when a deceleration of the vehicle (1) exceeds a predetermined value.

3. Method according to claim 2, characterized in that the predetermined value for the deceleration of the vehicle lies between 7 m/s² and 10.3 m/s².

4. Method according to claim 1, characterized in that a condition of lifting of the rear wheel (3) is determined as existing when a positive acceleration of the rear wheel (3) exceeds a predetermined value.

5. Method according to claim 4, characterized in that the predetermined value for positive acceleration of the rear wheel (3) lies between 2.5 m/s² and 7 m/s².

6. Method according to claim 1, characterized in that a condition of lifting of the rear wheel (3) is determined as existing when a ratio of speeds of the front wheel (5) and of the rear wheel (3) exceeds a predetermined value.

7. Method according to claim 1, characterized in that a condition of lifting of the rear wheel (3) is determined as existing when a ratio of decelerations of the rear wheel (3) and of the front wheel (5) exceeds a predetermined value.

8. Method according to claim 1, characterized in that a condition of lifting of the rear wheel (3) is determined as existing when a speed of slipping of at least one of the wheels exceeds a predetermined value.

9. Method according to claim 8, characterized in that said value of slipping of the rear wheel (3) lies between 1% and 5%.

10. Method according to claim 2, characterized in that the predetermined value for the deceleration of the vehicle lies between 8 m/s² and 9.7 m/s².

11. Method according to claim 4, characterized in that the predetermined value for positive acceleration of the rear wheel (3) lies between 3.5 m/s² and 5.5 m/s².

12. Method according to claim 8, characterized in that said value of slipping of the rear wheel (3) lies between 1.9% and 3%.

13. Device for controlling a braking system in a vehicle, the vehicle comprising at least one front wheel and at least one rear wheel, characterized in that the device comprises means for implementing a method according to claim 1.

14. Vehicle equipped with a device according to claim 13.
